(19) United States
(12) Patent Application Publication
(10) Pub. No.: US 2012/0164398 A1
(43) Pub. Date: Jun. 28, 2012

(54) METHODS OF MULTI-SHOT INJECTION MOLDING AND DURABLE POLYMERIC ASSEMBLIES MADE THEREFROM

(76) Inventor: David Reeder, Grand Blanc, MI (US)

(21) Appl. No.: 13/326,515

(22) Filed: Dec. 15, 2011

Related U.S. Application Data
(60) Provisional application No. 61/423,538, filed on Dec. 15, 2010.

(51) Int. Cl. B32B 3/00; B32B 38/08; B32B 37/24

(52) U.S. Cl. 428/195.1; 156/242; 156/150

(57) ABSTRACT

Metallized multi-component polymeric assemblies are formed by methods provided, including injection molding a first resin to form a first sub-component comprising a metal-platable polymer and injection molding second and third colored resins via a multi-shot injection molding process to form second sub-component having a second and third polymer. Select regions corresponding to the metal-platable polymer surface are metallized. The second and third polymers preferably have distinct colors from one another. The first and second sub-components are assembled and coupled together to form a decorative polymeric component assembly that is visible to an external environment.

### CROSS-REFERENCE TO RELATED APPLICATIONS

This application claims the benefit of U.S. Provisional Application No. 61/423,538, filed on Dec. 15, 2010. The entire disclosure of the above application is incorporated herein by reference.

### FIELD

The present disclosure relates to methods of multi-shot injection molding and metal plating polymeric articles made therefrom.

### BACKGROUND

This section provides background information related to the present disclosure which is not necessarily prior art.

Plastic materials are used in a wide variety of applications. For example, many plastic components are used in vehicles, such as automobiles, to provide reduced weight, cost, and increased corrosion resistance advantages, among other benefits. Accordingly, plastic materials are often used as decorative components, for example, in detailing and trim features or as indicia of brands, logos, emblems, and the like. It should be noted that such decorative components are used in a wide variety of applications, such as consumer goods, appliances, reflector components, and the like, and are not limited to merely vehicles. Many such plastic components have multiple surface finishes in a single component, such as a combination of one or more colored surface finishes and one or more metallic surface finishes. Desirably these types of components are durable, yet have an aesthetically pleasing appearance.

Currently, when a decorative molded polymeric component requires two distinct different surface finishes, such as a metallic surface (e.g., chrome finish) and one or more colored surfaces, the components are molded separately and then later assembled together. Thus, in conventional processes, a first component having a metallic surface finish is prepared and then joined with a second component having a colored surface in a sub-assembly process. By joining such distinct components together, the potential exists for gaps to occur along seams, edges, or joints, so that upon exposure to weather or other corrosive conditions, corrosion to the multi-surface plastic component may potentially occur. Because plastic decorative components may be used in applications where they are exposed to an external environment, including extreme weather conditions and exposure to UV radiation or corrosive agents, such plastic components may suffer from degradation or corrosion.

It would be desirable to develop a decorative molded polymeric component, particularly those having at least one metallized surface finish and at least one non-metallized surface finish, which can be produced in a streamlined process, while having greater robustness, quality aesthetics, durability, and corrosion resistance, for example.

### SUMMARY

This section provides a general summary of the disclosure, and is not a comprehensive disclosure of its full scope or all of its features.

In various aspects, the present disclosure provides methods for forming a polymeric component assembly having a metallized surface region and at least one colored surface region. Such a polymeric component assembly may be a decorative component, for example. In certain variations, a polymeric component assembly is formed by injection molding a first resin that forms a first sub-component comprising a first polymer, which is metal-platable. One or more regions of a surface of the first sub-component are metallized to form one or more metallized regions over the first polymer. The method also comprises forming a second sub-component via multi-shot injection molding of a second resin and a third resin. The second resin forms a second polymer having a first color and the third resin forms a third polymer having a second color. Preferably, the first and second colors are distinct from one another. The method further comprises coupling the first sub-component and the second sub-component together to form the polymeric component assembly. In the polymeric component assembly, a first colored region is defined by the second polymer corresponding to the first color and a second colored region is defined by the third polymer corresponding to the second color. Thus, the first colored region, the second colored region, and the one or more metallized regions form a surface of the polymeric component assembly exposed to an external environment. In various aspects, the two or more colored regions are visually distinct from the one or more metallized regions and hence form a visual pattern or decorative feature on a visible surface of the polymeric component assembly.

In other aspects, the present teachings provide a polymeric component assembly that comprises one or more metallized surface regions formed on a first injection-molded polymer that is metal-platable. The polymeric component assembly also comprises one or more first colored surface regions defined by a second injection-molded polymer that has a first color and one or more second colored surface regions defined by a third injection-molded polymer having a second color that is distinct from the first color. The second injection-molded polymer and the third injection-molded polymer are integrally formed with one another and further are coupled to the first injection-molded polymer. At least a portion of the one or more metallized surface regions, one or more first colored surface regions, and the one or more second colored surface regions are visible to an external environment.

In yet other aspects, the present disclosure also provides a decorative polymeric component assembly that comprises a first sub-component comprising a first injection-molded metal-platable polymer having a surface comprising one or more metallized surface regions. The decorative polymeric component assembly further comprises a second sub-component comprising a second injection-molded polymer and a third injection-molded polymer. The second injection-molded polymer has a first color and the third injection-molded polymer has a second color. Preferably, the first and second colors are distinct from one another. Further, the second injection-molded polymer and the third injection-molded polymer are preferably integrally formed with one another, for example, by multi-shot injection molding. In the decorative polymeric component assembly, the first sub-component and the second sub-component are coupled together. At least a portion of the one or more metallized surface regions, the second injection-molded polymer and the third injection-molded polymer are visible to an external environment. In various aspects, the one or more metallized regions and the second and third injection-molded polymers form a visual pattern or decorative feature on a visible surface of the polymeric component assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a process flow diagram of a first conventional process for forming a decorative plastic component having metallized and colored surfaces;

FIG. 2 shows a first conventional decorative plastic component having a surface with both metallized and colored regions formed by the first conventional process in FIG. 1, which is suffering from degradation and/or corrosion in one or more regions;

FIG. 3 is a process flow diagram of a second conventional process for forming a decorative plastic component having a metallized surface finish and colored regions applied by painting over the metallized surface finish;

FIG. 4 shows a second conventional decorative plastic component having a surface with both metallized and colored regions (where the metallized regions are in the form of indicia of the letters “LOGO”) formed by the second conventional process of FIG. 3, which is suffering from degradation and/or corrosion in one or more regions;

FIG. 5 is a process flow diagram for forming a decorative plastic component having a metallized surface finish and colored regions according to certain aspects of the present teachings;

FIGS. 6A-6B show an embodiment of a decorative plastic multi-component polymeric assembly having a first sub-component with a metallized surface finish and a second sub-component with at least two distinct colored regions formed according to certain aspects of the present teachings. FIG. 6A is a plan view of such a decorative component and FIG. 6B is a cross-sectional view taken along line B-B in FIG. 6A;

FIGS. 7A-7E show conventional decorative plastic components having a surface with both metallized and colored regions formed by conventional formation processes. The decorative plastic component in FIGS. 7A-7B are formed by the first conventional process and includes independent pieces that are assembled together by an adhesive material at a central region, while the component in FIGS. 7C-7D is made by the same first conventional process, but assembled by employing two adhesive materials disposed near terminal and opposite ends of the independent pieces. FIG. 7B is a detailed view of a terminal end of the component in FIG. 7A, while FIG. 7D is a detailed view of a terminal end of the component in FIG. 7C. FIG. 7E is a sectional view of yet another conventional decorative plastic component having a surface with both metallized and colored regions formed by a second conventional process where the colored surface finishes are painted over a metallized substrate;

FIGS. 8A-8H show yet other embodiments of a decorative plastic multi-component assembly formed according to certain aspects of the present teachings having a metallized surface finish and distinct colored regions. FIG. 8A is a plan view of a first plastic decorative multi-component assembly having a first sub-component with a metallized surface finish. FIG. 8B is a plan view of a second sub-component having two distinct colored surface finishes. FIG. 8C is a plan view of an assembled decorative component coupling the first sub-component and second sub-component. FIG. 8D is a cross-sectional view taken along line B-B in FIG. 8C. FIG. 8E is a plan view a first sub-component having a metallized surface for a second plastic decorative multi-component assembly having three separate sub-components. FIG. 8F is a plan view of a second sub-component having two distinct colored surface finishes. FIG. 8G is a plan view of a third sub-component having yet more distinct colored surface finishes. FIG. 8H is a plan view of an assembled decorative component coupling the first sub-component, second sub-component, and third sub-components together; and

FIG. 9 is an exemplary schematic showing a multi-shot polymer injection molding apparatus.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” and the like). As used herein, the term “and/or” includes any and all combinations of one or more of the associated listed items.

Although the terms first, second, third, and the like may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range, including endpoints given for the ranges.

The inventive technology pertains to an improved, streamlined process to make improved robust plastic components having both metallized and colored non-metallized surface regions. Further, the inventive technology includes the polymeric articles, such as decorative components, formed from such processes, as will be described in greater detail below. For a better understanding of the present teachings, a discussion of conventional processing techniques for forming plastic components (in particular those having a surface with at least one region defining a metallized surface and at least one region defining a colored non-metallized surface) is as follows.

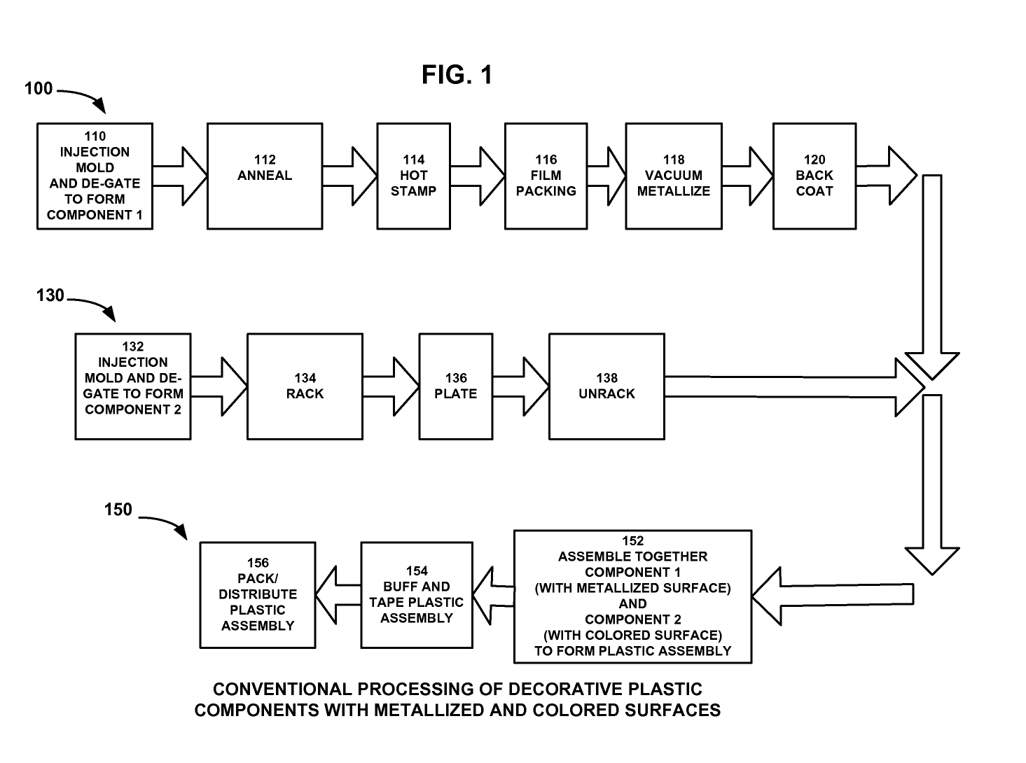

In one type of conventional process, such as that shown in FIG. 1, a first plastic or polymeric component is formed in a first process 100 and a second plastic or polymeric component is formed in a second distinct process 130. Later, the first plastic component and second plastic component are assembled together in a third process 150. In these processes, a simplified version of conventional processing steps is shown (omitting certain routine work-in-progress steps, where the component is stored to permit the completion of cooling, drying after processing, and the like). Thus, a conventional process 100 includes forming a first molded component that comprises a polymer by first injection molding the component (including optional curing or cross-linking while in the mold assembly) and de-gating it from a mold assembly at 110. Then, the first polymeric component is annealed at 112 (by heating to a temperature below the melting point of the injection-molded polymer to relieve internal stress) and hot-stamped at 114. Hot-stamping applies one or more paint films or surface finishes, such as a black paint film, by stamping such a film to heated regions of a surface of the first component. Further, multiple hot stamping steps may be conducted to apply different colors to the component (for example, four distinct hot stamping steps to apply four distinct colors). Next, the first component is subjected to a film packaging step 116, where a masking film (optionally having a pattern with regions to be protected) is applied to a surface of the first component (for example, by pulling a vacuum to apply the film to the surface).

After applying the masking film in 116, one or more regions of the surface of the first component are vacuum metallized 118. Vacuum metallizing is a common process well known to those of skill in the art for creating a metallized finish on plastic surfaces, such as a chrome surface finish on a polymeric component. Thermal evaporation, also commonly referred to as vacuum metallizing, is the most common physical vapor deposition (PVD) process used to apply metals and/or metal alloys under vacuum conditions. During the vacuum metallizing process, a metal or metal alloy, such as aluminum, is evaporated in a vacuum chamber, which condenses on and bonds to the surfaces of the plastic parts to form a uniform metallized surface layer.

After the metallizing takes place, a protective back coat is applied to the metallized surface regions at 120. Dyes and pigments can be added to such a back coat to modify the metallic finish color or appearance, for example, to change a shiny chrome finish to have a gold, nickel, bronze, copper, or gunmetal, color, for example. Thus, the first component having a metallized surface finish (formed via vacuum metallization) along with a colored region (from the hot stamping) is ready for assembly with a second component processed as discussed below.

In a second process 130, a second molded polymeric component is formed by injection molding a polymer resin (optionally cured or cross-linked) and de-gating it at 132. The second polymeric component is then arranged on a rack 134 and then subjected to a metal plating process 136, whereby one or more surface regions on the second polymeric component have a metallic appearance. By way of example, the surface to be plated can be etched, followed by optional electroless deposition of one or more layers and/or electroplating of one or more layers of metal-containing materials. The second component having one or more plated surfaces is then removed from the rack 138 and is ready for assembly with the first component having one or more metallized surface regions from process 100. It should be noted that both the first component and second component have metallized surfaces, although the first component also has a hot-stamped colored finish, as well.

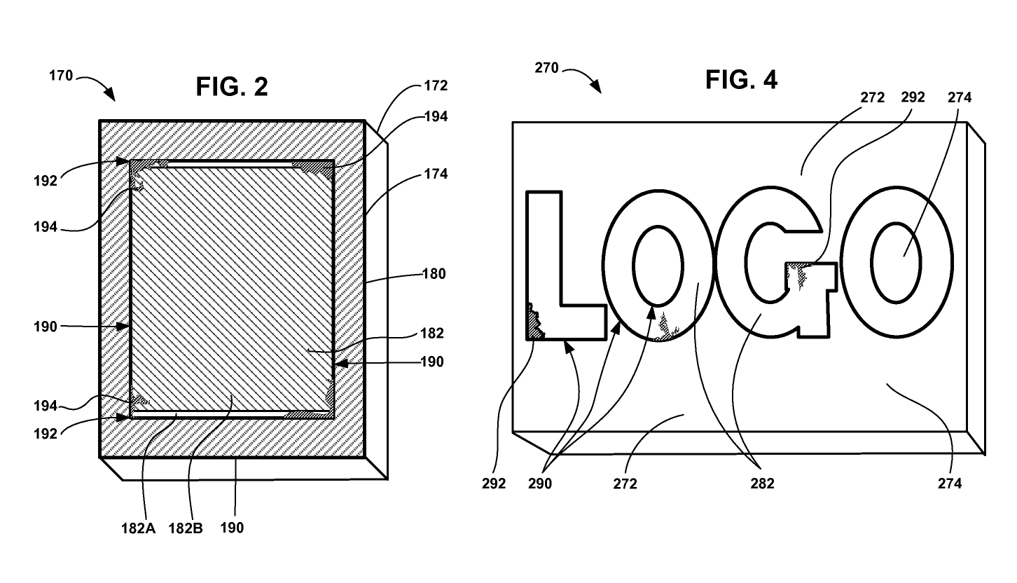

In a third process 150, the first component and second component are assembled together 152 via a conventional assembly process. For example, as shown in FIG. 2, an exemplary plastic decorative component 170 is shown, including a frame or bezel 172 and a lens 180. If the first component is a lens 180 and the second component is the bezel 172 that surrounds lens 180, the bezel 172 and lens 180 can be placed in contact with one another and joined together. Optionally, an adhesive or other material (not shown) disposed in one or more joint regions 190 between the first and second components 172, 180 to form an assembly that is the plastic decorative component 170. In certain variations, this assembly step may further include curing or cross-linking (for example, by room temperature vulcanization).

As shown in FIG. 1, the assembly can then be finished, for example, by buffing the finished surfaces (to remove any rough edges) and applying a tape or other adhesive to one or more surfaces, so that the assembly can be attached and coupled to a substrate in its final use 154. Finally, the assembled decorative component is packed for distribution at 156.

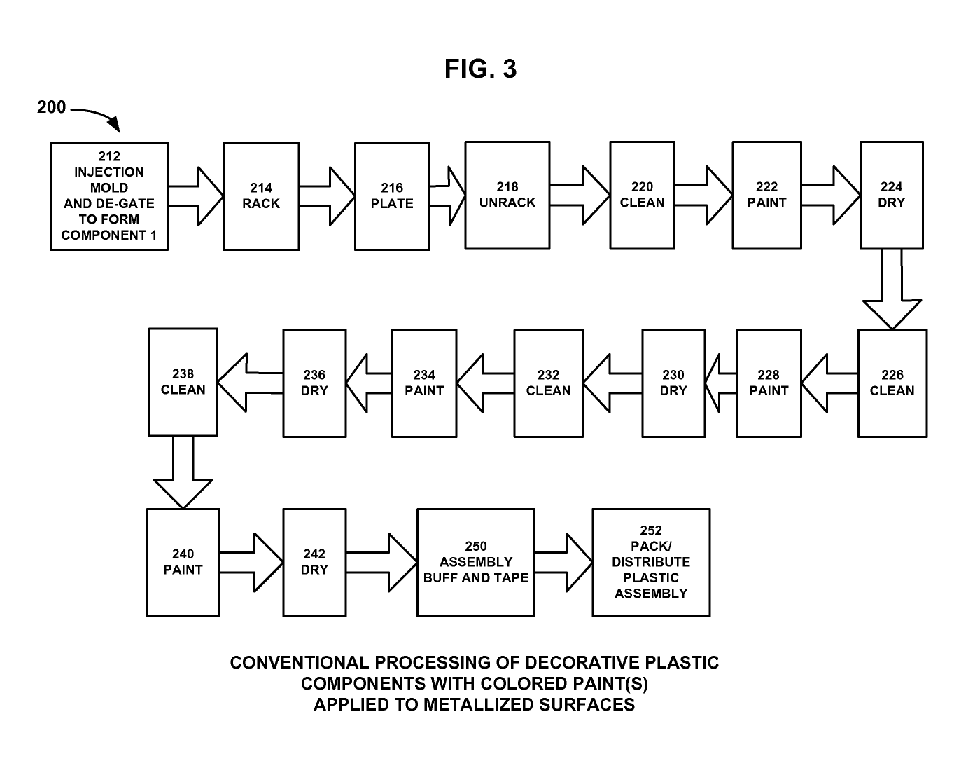

Yet another conventional process to form decorative plastic components (having both a metallized surface and a colored surface) is shown in FIG. 3, where a surface of the component is first metallized and then one or more colored paints are applied over the metallized surface. FIG. 3 shows such an exemplary conventional process 200. The polymeric component is formed by injection molding a polymer resin (optionally cross-linking) and de-gating it at 212. The polymeric component is then arranged on a rack 214 for further processing. The polymeric component on the rack is then subjected to a plating process 216, whereby one or more surfaces of the plastic component have a metallized surface appearance, such as a chrome finish. Such a plating process is similar to the plating process 136 described in the context of FIG. 1, where the surface of the polymeric component to be metallized can be subjected to a direct wet chemistry process, where the surface is etched and subjected to electroless and electrolytic plating processes.

By way of example, one particularly suitable metallization process includes a direct wet chemistry metallization process that includes wet etching, followed by an electroless plating process, and then a sequence of electroplating baths. Such a direct wet chemistry process can apply a chrome metal finish to the plastic surface. In one variation, etching is conducted by immersing the surface of the plastic component (or entire plastic component, for example, the rack holding the plastic component) in an etching solution comprising chromium (e.g., Cr (VI)) and sulfuric acid. After etching, the surface of the plastic component to be metallized (or the entire component itself) is subjected to an electroless plating process, which is an auto-catalytic process that applies a thin conductive metal layer (for example, a thin nickel-containing or copper-containing layer) onto the etched plastic surface, without the use of electric current.

After electroless deposition of such a conductive metal layer, the surface to be plated can be further subjected to wet chemistry metallic processing, which is well known in the art. One exemplary wet chemistry electroplating process to form a chrome-plated surface on the plastic component includes first electroplating one or more copper layers (Cu) over the electroless-deposited layer (comprising for example, a conductive metal like nickel and/or copper), followed by electroplating a nickel layer (Ni) and then a chromium (Cr) layer.

After plating, the polymeric component having one or more plated surfaces is then removed from the rack 218. Next, the polymeric component is cleaned 220, painted 222, and dried 224. In order to provide good adherence of paint over the metallized surface, one or more paints are applied to a surface of the polymeric component shortly after the metallizing process, preferably within 24 hours or less of metallizing the surface. Thus, the surface of the polymer can be cleaned with an alcohol solvent at 220, followed by painting with a conventional paint like an exterior body paint. In conventional processing, such paints are usually applied multiple times to ensure good paint coverage and adhesion or to apply distinct colors to the surface. For example, in a conventional process, the cleaning, painting, and drying steps are repeated another three times. See cleaning, painting, and drying steps 226, 228, 230; 232, 234, 236; and 238, 240, and 242, respectively. Then, the processed component can be finished and assembled 250, for example, by buffing the finished surfaces and optionally taping one or more surfaces of the component to ensure its adhesion to a substrate for end use. Finally, the assembled decorative component is packed for distribution at 252.

Decorative polymeric parts formed by the conventional processes shown in FIGS. 1 and 3 require a relatively large number of processing steps, which in addition to requiring greater material resources and energy, also require significant tooling and processing times. In process 200 where paint is applied over a metallized surface on the injection-molded part, it can be difficult to process such a part successfully, both due to the short/tight process window (to apply paint within a short time of metallization of the surface) and to control the environment during application of paint, including carefully controlling temperature and humidity, which can have a significant impact on paint adhesion to the underlying metallized surface.

Furthermore, it has been observed that decorative components formed by the multi-part assembly and vacuum metallization/plating processing (processes 100, 130, and 150) in FIG. 1 and the paint applied over metal-plated surfaces formed by the process 200 of FIG. 3 have the potential to suffer from environmental degradation, solvent attack, peeling, and/or delamination issues. For example, in an automotive application, a decorative component of the vehicle may be coupled to a new manufactured vehicle and then subjected to final processing and finishing steps, often including applying a water-repellant material over the entire external surface of a vehicle, such as the commercially available RainX™ material. Such a material usually contains solvents and thus, has the ability to penetrate any seams, joints, or edges in the decorative plastic component providing the potential for corrosive agents to degrade the decorative surfaces. Further, when exposed to environmental conditions, corrosive elements may penetrate the decorative component's edges, seams, or joints, which likewise have the potential to cause unacceptable degradation of one or more surfaces of the decorative component.

Such corrosive attack or degradation is shown in the exemplary schematic of FIG. 2. FIG. 2 is a decorative plastic component 170 formed by a process like that described in conjunction with FIG. 1 (process 100) discussed above. In this exemplary emblem, a decorative component 170 comprises a bezel or frame 172 having a first surface finish 174. The decorative component 170 also has a central lens 180 having a second surface finish 182. The first and second surface finishes 174, 182 may be distinct from one another, for example, a colored surface finish and a metallized surface finish. As described above, the central lens 180 has a second surface finish 182 that includes two distinct surface finishes, including a colored surface finish (e.g., hot-stamped colored surface) 182A and a metallized surface finish (e.g., vacuum-metallized surface) 182B. The bezel 172 has a first surface finish 174 that is a metallic finish (e.g., plated metal).

A joint 190 is formed between the frame 172 and lens 180, where the pieces are joined and assembled together to form the decorative component 170. As shown in FIG. 2, at the corner regions 192 of the joint 190, the second surface finish 182 is suffering from corrosive attack (shown as delaminated or corroded regions 194). Such corrosive attack may occur anywhere along the surface and is not limited to the regions shown in FIG. 2, but tends to occur at joints, seams, or edges between distinct components (e.g., between frame and lens 172, 180). Further, the decorative plastic component may have far more complex shapes and designs than those shown in FIG. 2 and may include additional components or pieces; therefore such corrosive attack may occur in a variety of locations.

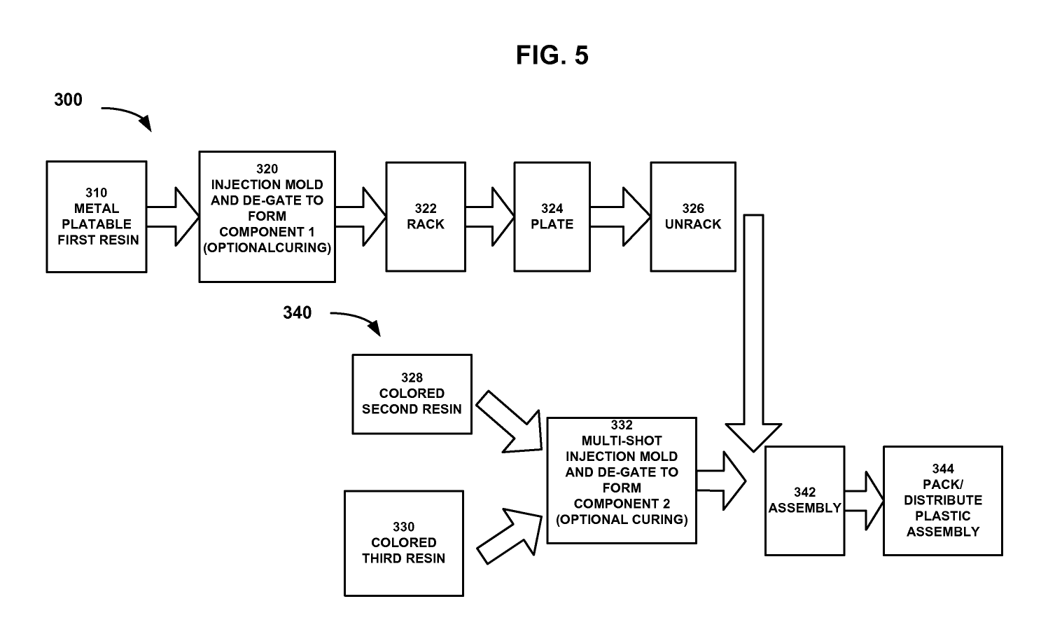

Similarly, decorative components formed via the processes discussed in conjunction with FIG. 3, where paint is applied over a metallized surface suffer from similar corrosive attack or delamination, as shown in the representative design of FIG. 4. An exemplary decorative plastic component 270 comprises a major surface 272 having one or more regions 274 with a first surface finish, such as a metallized surface finish (e.g., formed by plating). As appreciated by the discussion above, such a metallized finish can be applied to cover the entire major surface 272 or may be applied in discrete or distinct surface regions. The major surface 272 also has a second surface finish 282 formed in one or more regions (here in the regions designated “LOGO”). The second surface finish 282 can be applied over the first metallized surface finish 274 by masking, so that only the regions where the second surface finish 282 is to be formed are contacted with paint during the painting process. The second surface finish 282 may be a colored surface formed by applying one or more layers of paint over the metallized surface finish 274. Further, multiple distinct paint colors can be applied to form the second surface finish 282. The second surface finish 282 may include a plurality of different paint colors, as well.

Several edges 290 are formed at the interfaces between the first metallized surface finish 274 and the second painted surface finish 282 along the surface 272. As shown in FIG. 4, certain regions of the edges 290 (between the first and second surface finishes 274, 282) are suffering from degradation and/or corrosive attack (shown as peeling/delaminated regions 292). Such degradation may occur at any location, especially at joints, seams, or edges, but is not limited to the embodiment shown here. Similar to the decorative component of FIG. 2, the decorative component 270 is merely exemplary and may have far more complex shapes and designs; therefore such corrosive attack may occur in a variety of regions corresponding to the complex design.

In view of some of the potential shortcomings of the conventional processing techniques for forming decorative plastic components having at least two distinct surface finishes (e.g., a colored non-metallized surface finish and a metallized surface finish), the present teachings provide a streamlined and more efficient process for forming such decorative components having improved robustness and durability, while exhibiting diminished susceptibility to degradation or corrosive attack. In certain variations, the improved processes can potentially eliminate the need for masks, racks, extra tooling and steps and the like. Additionally, decorative components formed from the various processes of the present disclosure have reduced susceptibility to chemical attack and can eliminate potential peeling and delamination of the colored surface finish applied to a metallized surface finish.

In various aspects, the present disclosure provides a polymeric component assembly, such as a decorative molded polymeric component assembly, comprising having one or more metallized surface regions and one or more non-metallized colored regions. By “metallized” it is meant that the surface of the plastic has a metallic surface finish or metallic appearance and in preferred aspects, comprises a metallic material containing one or more metals or metal alloys. A surface having one or more of such metallized regions includes an entire major surface of the plastic component being covered with a metallic material (so that a single metallized region covers an entire surface) or may include discrete and distinct regions (either contiguous or non-contiguous regions) of metallic material along the surface. A “non-metallized” surface region is one that has minimal metal present or that is substantially free of metal, so that the surface region does not appear to have a metallic surface finish or metallic appearance, in contrast to the metallized surface regions. In certain preferred aspects, the non-metallized surface region has a colored surface finish (or multiple colored surface finishes) that may include coverage of an entire major surface, but also includes partial surface coverage, including both contiguous and non-contiguous colored surface regions.

In various embodiments, metallized surface regions are formed over a first polymer that is metallizable, such as a metal-platable polymer. For example, a first sub-component can be formed having one or more metallized surface regions, while a second sub-component can be formed having one or more non-metallized colored regions. In preferred aspects, the second sub-component comprises at least two colored surface regions having two distinct colors. In certain aspects, such non-metallized surface regions may be formed and defined by a polymer that is resistant to metallization, in particular resistant to metal deposition during a metallization process. Metallization can include deposition of a metal selected from the group of non-limiting metals: copper, iron, zinc, cobalt, palladium, chromium, magnesium, manganese, cadmium, niobium, molybdenum, gold, palladium, nickel, tungsten, and combinations thereof. As will be discussed in greater detail below, in certain embodiments, the metallized surface region has a chrome appearance (or a chrome-plating) and includes deposition of metals selected from the group consisting of: nickel, copper, chromium, and combinations thereof. In addition to deposition of metallic elements, a non-metallic element can be co-deposited with the metal (for example phosphorous or boron). In certain aspects, the metallization process is a metal-plating process, such as a preferred direct wet metallization chemistry process. The metallization can be carried out by first etching the surface of the polymeric component to be metallized followed by immersion in a bath of a metallization liquid composition (solution, dispersion, gel, emulsion, and the like) with or without an electrical current.

In various embodiments, the molded polymeric component also comprises a surface that has one or more colored surface regions defined by a second sub-component comprising a second polymer and a third polymer. Preferably, the second polymer has a first color and defines one or more first colored surface regions. Further, the third polymer has a second color that defines one or more second colored surface regions. In certain aspects, the first and second colors are distinct from one another so that the one or more first colored regions are distinct from the one or more second colored regions. A “colored” surface finish includes exhibiting a color in the visible wavelength range, which has a degree of contrast in opacity and/or color spectrum as compared to other surface regions (particularly from the metallized surface regions). In certain aspects, a colored surface region may correspond to non-metallized regions, so that the colored regions are substantially free of metallization. As noted above, a colored region that is substantially free or entirely free of metallization does not have a metallic surface finish to an observer of the surface. The colored region(s) can optionally cover an entire major surface of the molded sub-component assembly or alternatively, may cover discrete and distinct regions along the surface, for example, to define one or more visible features or patterns. In certain embodiments, the decorative molded polymeric component thus comprises a second sub-component that comprises a colored second polymer that defines at least one first colored region of the decorative component's surface having a first color and further comprises a colored third polymer that defines at least one second colored region having a second color distinct from the first, so that the second sub-component has a multi-colored surface finish. In certain aspects, the polymer forming the colored regions is resistant to metallization, like metal-plating, and therefore is not metallized (e.g., is substantially free of metal or entirely free of metal and therefore does not have a metallic surface finish). In certain variations, multiple colored polymers are used to define three or more distinct colored surface finishes corresponding to multiple non-metallized surface regions.

In various embodiments, the first sub-component is formed by injection molding a first resin and the second sub-component is formed by injection molding a second resin that forms the second polymer and a third resin that forms a third polymer. The first injection molded sub-component (comprising the first polymer) is later assembled with the second injection molded sub-component (comprising the second and third polymers) to form the polymeric component assembly. In certain preferred aspects, the second sub-component is formed via a multi-shot injection molding process that will be described in greater detail below. A “resin” as used herein is an organic material, typically of high molecular weight, such as a polymer, which may be a polymer precursor, for example, monomers and/or oligomers capable of subsequent cross-linking or further reaction, or may comprise a cross-linked or cured polymer. In certain aspects, resins exhibit a tendency to flow when subjected to stress, thus, may be a liquid or viscous polymer or polymer precursor that is capable of being injected into a polymer injection mold cavity. In certain variations, a curing process transforms the resin into a polymer by a cross-linking process.

In various aspects, the first sub-component is formed by injection molding the first resin to form the metal-platable resin, which is subsequently treated to have one or more metallized surface regions. Further, in various aspects, the second polymer and the third polymer are integrally formed and thus create a single, unitary body, for example, formed by multi-shot injection molding of the second resin and third resin in the same process, so that they are bonded or fused together. Thus, after multi-shot injection molding formation of the second and third polymers, a multi-colored second sub-component is formed containing both the second and third polymers. When the first sub-component and the second sub-component are assembled together, the molded multi-polymeric component assembly optionally has at least a portion of the one or more metallized surface regions and at least a portion of the one or more colored surface regions visible to an external environment, so that it is particularly suitable as a decorative component.

In certain embodiments, each sub-component that forms the molded polymeric component assembly optionally comprises a plurality of distinct polymers. The plurality of distinct polymers may form distinct surface regions that may be mutually exclusive and non-overlapping or alternatively may completely or partially overlap. For example, the present disclosure contemplates a plurality of polymers that can be metallized in the first sub-component and a plurality of polymers in the second sub-component, in addition to the second and third polymers, that have different colors. Further, in certain variations, the molded polymeric component also comprises a third polymer.

In certain preferred aspects, the second and third polymers are stable in the presence of ultraviolet (UV) electromagnetic waves. Additional colored polymers (in addition to the second and third polymers) may be an injection-molded polymer (for example, formed concurrently with the second and third polymers during multi-shot injection molding) or alternatively, may be injection molded as a separate third sub-component that can be coupled to the first sub-component and/or the second sub-component during the assembly process. Further, a third sub-component may comprise a plurality of polymers, for example, a fourth polymer having a third color and a fifth polymer having a fourth color, where the third and fourth colors are distinct from one another. The fourth and fifth colors may optionally be the same as the first and second colors (for example, if complex colored designs are required and it is easier to form two separate sub-components in two separate molds). Alternatively, the third and fourth colors may be distinct from the first and second colors.

In yet other variations, the present teachings provide a plastic or polymeric component that comprises a first sub-component comprising a first metal-platable polymer formed from an injection-molded first resin, for example. The first sub-component formed by the first polymer is metallized to have a first surface comprising one or more metallized regions. The decorative molded polymeric component also comprises a second sub-component comprising a second injection-molded polymer having a first color and a third-injection molded polymer having a second color, that are respectively formed from a second resin and a third resins. The second sub-component formed by the second and third polymers has a second surface comprising one or more first colored regions corresponding to the first color of the second injection-molded polymer and one or more second colored regions corresponding to the second color of the third injection-molded polymer. Further, in certain aspects, when assembled together, the one or more metallized surface regions of the first sub-component and the one or more first colored surface regions and second colored surface regions of the second sub-component are arranged together to define a three-dimensional surface profile (having raised and depressed surface features, such as grooves, ridges, and the like so that the component assembly surface is dimensioned). Such three dimensional surface features are visible to the external environment and add to the complexity and aesthetics of a decorative component.

Optionally, the decorative molded polymeric component may comprise one or more protective layers formed over a surface of the decorative component defining the metallized surface finish or the colored surface finishes. In certain variations, such a protective layer comprises a transparent polymer, such as a UV-stable transparent polymer. Thus, the decorative molded polymeric component also optionally comprises a layer comprising a transparent polymer. In certain variations, the transparent polymer can be formed by an additional transparent resin (e.g., a third resin) that is injection-molded. Such a protective layer can be disposed adjacent to at least one of the first or second sub-components or may be multi-shot injection molded with the second sub-component for example. When assembled, the transparent polymer protects the underlying first and/or second sub-components from exposure to an external environment. In certain aspects, the transparent resin forming the protective layer may cover or encapsulate one or more edges or interfaces defined between the first or second sub-components or interface regions between the metallized and colored surface finishes.

Thus, in preferred variations, a molded decorative subcomponent of the present teachings is formed by an injection molding process, which is typically an automatic process where a hydraulic press can be used (e.g., a hydraulic press that is generally horizontally-oriented), where the molding resin(s) is screw injected into one or more closed mold cavities (optionally having one or more cores disposed therein) via a sprue and a system of gates and runners. Pressure is then applied at the appropriate temperature to solidify the part. The mold is opened for part ejection and removal, the mold is closed, and the next charge is injected by the screw. As noted above, the first sub-component can be formed by conventional injection molding of a metal-platable resin to form a metal-platable polymer. The second sub-component is preferably formed by a multi-shot injection process, where multiple resins are injected sequentially to form multiple distinct colored resins.

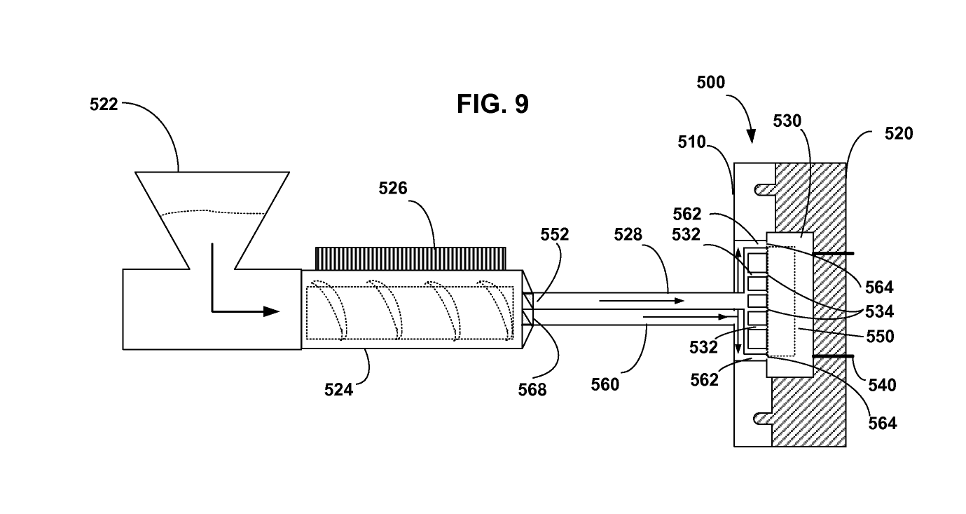

By way of non-limiting example, an exemplary simplified injection molding process configured for multi-shot injection molding is shown in FIG. 9. A mold assembly 500 comprises two primary components, the injection mold (A plate, 510) and the ejector mold (B plate, 520). Plastic resin (usually fed to a hopper 522 as pellets) enters a screw conveyor 524, which includes a heater 526 that applies heat to the resin material. The resin passes through the screw conveyor 524 to a first sprue 528 to apply heat to the resin while it is pressurized and fed via screw conveyor 524. The resin enters a cavity 530 in the mold 500 through the first sprue 528. As shown, sprue 528 directs the molten plastic resin to a plurality of open channels or runners 532 that are formed (e.g., by machining) into the faces of the A and B plates 510, 520 and lead to the cavity 530 defined by the mold assembly 500. The molten resin flows through the first runners 532 and enters one or more specialized gates 534 to enter into the cavity 530 to form the desired part having a shape defined by the cavity.

The mold assembly 500 can be heated and/or cooled in different regions through external control systems (with heat transfer channels or heating elements built into the mold and/or ejector, not shown in FIG. 9). The mold assembly 500 is usually designed so that the molded part reliably remains on the ejector side (B plate, 520) of the mold assembly 500 when it opens, and draws the portions of first runners 532 and the sprue 528 filled with resin out of the plate A side 510. The molded component is then readily ejected from the plate B 520 side. The molded component is removed from the runner system by ejection from the mold assembly 500, for example, by ejection from plate B side 520. Ejector pins 540, also known as knockout pin, include one or more circular pins placed in either half of the mold assembly (usually the ejector half 520), which pushes the finished molded product, or runner system out of the mold assembly 500.

Two-shot or multi-shot molds are designed to “overmold” within a single molding cycle and can be processed on specialized injection molding machines having two or more independent injection units. Multi-shot injection molding includes separate injection molding processes performed multiple times. For example, in a first step, a first resin is molded into a first cavity or first region or volume of a cavity to form a molded article having a basic shape. Then, a second material is injection-molded into the remaining open spaces (for example, defining a second cavity or void region within the first cavity around the first region). The void space is then filled during the second injection step with a distinct resin material and thus forms a second molded article comprising both the first molded resin material and the second molded resin material integrally formed into a single molded component. In certain variations, the first and second cavities are substantially separated from one another (independent cavities defined in the mold assembly); although such separate cavities may have some interconnection points or openings between them to facilitate interconnection, fusing, or bonding of the polymeric parts together. In yet other aspects, the present disclosure contemplates a mold that is rotatable from a first position where the first resin is injected into a first cavity. The mold is rotated or translated to a second position, where a second resin is injected (for example, at different gates leading to a distinct second cavity.) The second cavity may be interconnected at least in part with the first cavity to ensure that the second resin contacts at least a portion of the first resin so that they may be integrally formed.

In various aspects, a sub-component of the molded decorative component of the present teachings can be formed by multiple-shot injection molding. “Multiple-shot injection molding” refers to an injection molding process for forming a molded polymeric article formed by first forming a predetermined shape by a primary molding of a first resin composition to give a first molded portion of the article, and integrally molding at least one other resin composition in contact with the first resin composition. Integral molding refers to forming a first molded article comprising a first molded material from a first molding process that is combined with a second molding process that adds one or more supplemental molded materials in contact with the first molded article thereto, thus forming an integral, monolithic second molded article comprising both the first molded material and the supplemental molded material(s) molded and interconnected together.

As shown in the simplified schematic of FIG. 9, a multi-shot injection system includes a first sprue 528 that leads to a plurality of first channels/runners 532 and plurality of first gates 534 into the mold cavity 530. When the first resin is injected into the mold cavity 530, it may only occupy a first portion of the cavity (see for example, the area or volume designated 550 in the cavity 530). The first sprue 528, the first runners 532, or first gates 534 may optionally comprise one or more valves or other means to prevent resin flow (shown in FIG. 9 as a valve 552 in sprue 528). As appreciated by those of skill in the art, the placement and number of sprues, runners, gates, and valves is not limited to exemplary embodiment shown here. A second sprue 560 leads to a plurality of second runners 562 that end in a plurality of second gates 564, which open to mold cavity 530. Different materials can be fed to the same hopper 522 and screw feeder assembly 524 in this molding apparatus configuration, although in alternative embodiments, the feeding systems may be independent from one another (including independent hoppers, screw feeders, sprues, and the like). During the process of feeding of the first resin to the mold cavity 530, first valve 552 in first sprue 528 is open, while a second valve 568 in the second sprue 560 is closed to permit the first resin to flow into the first runners and first gates 532, 534. Then, a first valve 552 is closed and the second valve 568 is opened. A second resin can then be fed through the open valve 568 to the mold cavity 530 via sprue 560, second runners 562, and second gates 564. The second resin enters the remaining void regions of the cavity 530 (for example, in the unoccupied regions surrounding area 550) and thus is over-molded to the first resin material to form an integrally molded multi-polymer component.

The most simplified multi-shot injection process is a “two-shot” injection molding for two distinct resins; however, injection of multiple resins in excess of two is also contemplated. Further, integral molding of the same or other resin compositions can also be carried out in contact with a previously molded composition of the article to build upon and create yet another article. For clarity, the first and second resins that form a second multi-polymeric sub-component are referred to herein as “second” and “third” resins to distinguish them from the first resin that is injection molded to form the first subcomponent. The final multi-shot molded sub-components thus formed by conventional injection molding or multi-shot molding are preferably subjected to cross-linking or curing (for example, while still contained in the injection mold assembly).

Further, the first sub-component can be exposed, submerged or partially dipped into a bath of metallization liquid composition. Such metallizing can include optionally subjecting the first sub-component to etching, a catalyst, or other treatments as a pretreatment for metallizing (one or more times) of the final molded article, if desired, to form a metallized region containing a metal material. Thereafter, specific surface regions of the first sub-component have a metallized surface finish applied. Notably, in various embodiments, the second sub-component has surface regions that are colored, but substantially free of any metallization.

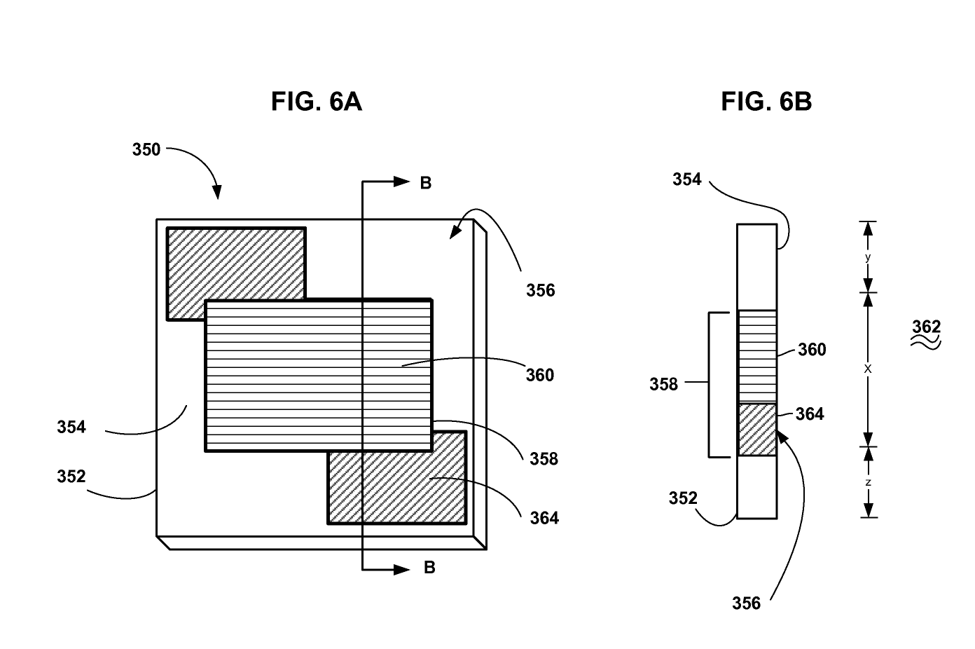

Thus, in various aspects, the present disclosure provides methods for forming a decorative molded polymeric component. For example, as shown in FIG. 5, in certain embodiments, the methods of the present teachings include two distinct injection molding processes. In a first process, a first metal-platable resin (that forms a first metal-platable polymer) is injection molded to form the first sub-component. Likewise, in second process, a second colored resin having a first color and a third colored resin having a second color are injection molded in a multi-shot injection molding process to form a second sub-component. The second sub-component has a second molded polymer having the first color that defines one or more first colored surface regions and the third molded polymer with the second color that defines one or more second colored surface regions.

As discussed above, typically in multi-shot polymer injection molding, an initial resin is injected into a first gate of a mold that defines a first cavity (or multiple first cavities). The initial resin is injected to fill the first cavity of the mold. The mold also defines a second cavity (or multiple second cavities). Then, a subsequent resin is injected into the mold. In certain aspects, the second cavity is designed to contact the first cavity in specific regions, so that the subsequently injected resin is overmolded onto the initially injected resin occupying the first cavity. Further, the mold may rotate to provide access to distinct gates in the mold to access distinct cavities. The first and second cavities may optionally be designed to have one or more locking features to secure the polymer formed from the initially injected resin to the other polymer formed from the later injected resin.

In certain preferred aspects, the resin compositions that are used in the present methods can have different melting or transition point temperatures (e.g., in the case of polymers, such a melt temperature may reflect a glass transition point temperature or a softening temperature, for example, a temperature at which the polymer transforms from a crystalline or semi-crystalline structure to an amorphous structure). It is desirable to mold the third resin composition at a temperature that is lower than the melt temperature of the second molded composition. During molding, partial softening and/or melting at the areas where the two materials are in contact can promote adherence and bonding of the two materials. In certain variations, the contacting surfaces of the molded compositions can be designed with features to improve the bond strength between the contacting surfaces of the integrally molded materials. For example, one molded material surface can have one or more channels, locking features, ridges, pits, buttons, holes, pores, tunnels and the like, including any structures or bonding known to those in the injection molding arts.

In certain aspects, the second resin has a higher melt flow rate and/or melt flow index than a third resin, which is injected and fills the first cavity of the mold prior to introduction of the third resin. The third resin has a lower melt flow rate and/or melt flow index than the second resin, which is injected after the second resin into the mold. In this regard, the third resin will be molded over the second resin (so that they are integral and coupled with one another by interlocking or bonding together), but is injected at a lower temperature that will not melt or otherwise undesirably physically distort the shape of the earlier piece formed by the second resin having the higher melt flow rate and/or melt flow index.

Therefore, in certain variations, the molding of separate compositions can be done at different melt temperatures or different mold injection temperatures. Preferably, the difference of melt temperatures of the second and third resins or different in mold injection temperatures is at least about 25° Celsius. The mold temperature may be the same for the one, two, or more mold cavities, or it may be different.

In certain embodiments, the multi-shot injection forms a first molded article from a second resin and a second molded article from a third resin that together form an integrally formed second sub-component. In one embodiment, a first molded article is molded of a second resin composition having a first melting or maximum injection temperature, and the later molding (of the second and/or third resin compositions) is made at an injection temperature at least 50° Celsius lower than that melting temperature or injection temperature of the second resin composition of the first molded article. In other embodiments, the first molding injection temperature or second resin melting point is greater than or equal to about 55° C.; optionally greater than or equal to about 60° C.; optionally greater than or equal to about 70° C.; optionally greater than or equal to about 80° C.; optionally greater than or equal to about 90° C.; optionally greater than or equal to about 100° C.; optionally greater than or equal to about 115° C.; optionally greater than or equal to about 125° C.; optionally greater than or equal to about 150° C.; and in certain aspects, optionally greater than or equal to about 175° C. higher than that melting temperature or injection temperature of the third resin composition that forms the second molded article.

In other variations, viscosity can be used to determine flow properties (other than molecular weight and melting point/transition temperatures). For example, the melt flow index (MFI) is related to molecular weight of the polymer and measures how much a resin material flows through an orifice over a given time period under a constant pressure. More specifically MFI is defined as the mass of polymer (e.g., resin), in grams, flowing in ten minutes through a capillary of a specific diameter and length by a pressure applied via prescribed alternative gravimetric weights for different prescribed temperatures. The method is described in the similar standards ASTM D1238 (Standard Test Method for Melt Flow Rates of Thermoplastics by Extrusion Plastometer) and ISO 1133 (Plastics—Determination of the melt mass-flow rate (MFR) and the melt volume-flow rate (MVR) of thermoplastics).

MFR is similar to MFI and is an indirect measure of molecular weight, with high melt flow rate corresponding to low molecular weight. At the same time, melt flow rate is a measure of the ability of the material's melt to flow under pressure. Melt flow rate is inversely proportional to viscosity of the melt at test conditions, although viscosity for any such material depends on the applied force. Generally, lower viscosity resins require lower temperatures during injection molding and higher viscosity having the highest molding temperatures.

Accordingly, in certain embodiments, the second resin composition can have a melt flow rate of greater than or equal to about 10 g/10 minutes to less than or equal to about 30 g/10 minutes; optionally from greater than or equal to about 12 g/10 minutes to less than or equal to about 20 g/10 minutes; optionally from greater than or equal to about 12 g/10 minutes to less than or equal to about 15 g/10 minutes, as measured under standard temperature and applied force conditions (e.g., per ASTM D1238). Similarly, in certain embodiments, the third resin composition has a melt flow rate of greater than or equal to about 2 to less than or equal to about 10 g/10 minutes; optionally greater than or equal to about 3 to less than or equal to about 7 g/10 minutes; optionally greater than or equal to about 3 to less than or equal to about 5 g/10 minutes as measured under standard temperature and applied force conditions (e.g., per ASTM D1238).

Once the molded component is pre-formed via multi-shot injection molding, in certain preferred variations, cross-linking of the resins is performed to facilitate bonding of the first resin material to the second resin material and to form the first polymer and second polymer therefrom. In certain preferred aspects, cross-linking occurs by heating the second and third resins during the injection molding process or heating the mold plates while the resins are being held in the mold assembly (prior to de-gating the component). Likewise, the first resin can be cross-linked by heating the mold after injecting the first resin to form the first polymer.

Cross-linking can also occur by applying actinic radiation, such as X-rays, gamma rays, ultraviolet light, visible light or alternatively, electron beam radiation, also known as e-beam. Ultra-violet radiation (UV) typically includes radiation at a wavelength or a plurality of wavelengths in the range of about 170 nm to 400 nm. Ionizing radiation typically includes means high energy radiation capable of generating ions and includes electron beam radiation, gamma rays and x-rays. E-beam means ionizing radiation of an electron beam generated by Van de Graff generator, electron-accelerator, x-ray, or the like. Such radioactive cross-linking can occur at elevated temperature such as when both first and second resin materials are placed together at above the melting point of either component or at room temperature or at any temperature there between.

In accordance with preferred aspects of the present teachings, the first resin forms a first metal-platable polymer, as where the second and third resins are selected so that they form a second polymer and a third polymer, respectively, that preferably define distinct colored non-metallized surface finishes. The specific polymeric/resin materials will be in more detail below. It should be further noted that multiple resins, whether selected to be metal-platable resin or colored resins, can be injected sequentially into a mold to form a component having various distinct surface finishes or to provide protective layers in certain variations. In other words the number of resins is not limited to a single first resin, second resin, and third resin, but optionally includes may include a plurality of resins, including a fourth resin, a fifth resin, a sixth resin, and the like. As discussed above, a third sub-component may be injection molded of such colored or metal-platable resins, which can later be assembled with the first and second sub-components.

With renewed reference to FIG. 5, the first metal-platable resin 310 is introduced into an injection mold and preferably is cross-linked 320 to form a first sub-component (Component 1) 320. Then, the first sub-component is racked 322 and metallized at 324. The metallizing may be done by any known technique, including electroless or electrolytic deposition.

In preferred aspects, metallization occurs predominantly or exclusively on a surface of one polymer composition (the first metal-platable polymer formed from the first metal-platable resin). Such metallization may be contiguous metallization found over an entire surface of the polymer sub-component or may by formed on only a portion of a surface of the polymeric sub-component (in discrete, contiguous, or non-contiguous regions).

For example, after racking at 322, the first sub-component may optionally be plated with one or more metals in an electroless bath and electroplating deposition bath 324, such as those conventional plating techniques described above. By way of example, one particularly suitable metallization process includes etching, followed by an electroless plating process, and then a wet chemistry metallization bath to apply a chrome metal finish to the plastic surface.

By further way of example, one particularly suitable metallization process includes wet etching, followed by an electroless plating process, and then a wet chemistry metallization bath to apply a chrome metal finish to the plastic surface, as described previously above. In one variation, etching is conducted by immersing the surface (or entire plastic component) in an etching solution comprising chromium (e.g., Cr (VI)) and sulfuric acid. While not limiting the present teachings to any particular theory, it is theorized that wet etching increases surface roughness and surface area of the metal-platable first polymer. For example, the etching solution is believed to remove or react with some of the butyl diene groups at the surface of the first polymer. Such an etching step is believed to alter the surface properties of the surface of the metal-platable first polymer enhances deposition of metal-containing material(s) thereto.

For example, in one embodiment, after etching, the surface of the first polymeric sub-component to be metallized (or the entire component itself) is subjected to an electroless plating process, which is an auto-catalytic process that includes applying a thin conductive metal layer onto the etched plastic surface without the use of electric current. In certain aspects, the electroless bath may contain and deposit metal elements selected from the group consisting of: nickel (Ni), copper (Cu), and combinations thereof. In addition to deposition of such metallic elements, a non-metallic element can be co-deposited with the metal (for example phosphorous (P) or boron (B)). In one embodiment, such an electroless bath may comprise a medium phosphorus electroless nickel bath (comprising about 7% phosphorus (P)). Thus, the electroless plating process in certain variations deposits at least one metal selected from the group consisting of: nickel (Ni), copper (Cu), and combinations thereof to a surface of the polymer of the first sub-component to be metallized.

After electroless deposition of such a conductive metal layer, the surface to be plated can be further subjected to wet chemistry processing, which is well known in the art. One exemplary wet chemistry electroplating process that forms a chrome-plated surface on the plastic component, includes electroplating first a copper (Cu) layer over the electroless-deposited layer comprising phosphorus and nickel, followed by electroplating a nickel layer (Ni) and then a chromium (Cr) layer. In such a wet chemistry process, the following non-limiting steps can be used to metallize the surface of the plastic component (after etching and electro-less deposition) via contact with or preferably immersion in baths or plating solutions. For example, several distinct plated layers of copper (Cu) metal can be applied sequentially, followed by acid activation. Then, several nickel (Ni)-plated layers can be applied over these Cu plated layers. The final Ni-plated layer can then be activated by a Cr bath, where a Cr plate is deposited. This Cr plating is then followed by a caustic stripping and then an acid stripping process to form a metallic region on the polymer surface having a chrome appearance.

A metallization process can also include a variety of metallization-promoting ingredients, which are known in the art to achieve metallization faster, achieve improved adherence or thickness, or so that metallization can be conducted at lower temperatures, and the like. Metallization-promoting ingredients can include salts, fillers, crystals, polymers, hydrophilic polymers, amide polymers, clays, minerals, and calcium carbonate, and amide polymers, by way of non-limiting example. Therefore, the molded first sub-component piece is metal-plated in one or more surface regions corresponding to the first metal-platable polymer to create one or more metallized surface regions. The first sub-component is then un-racked at 326.

In a second process 340, a second sub-component is formed by injecting a second colored resin into a mold of a multi-shot injection molding apparatus 328. Then, a third colored resin is subsequently introduced to the mold at 330. At 332, the second sub-component is injection molded with the second and third resins and preferably cross-linked to form a second polymer having a first color and a third polymer having a second color, where the first and second colors are distinct from one another. After formation of the multi-colored polymeric second sub-component, the second sub-component is ready for assembly with the first sub-component at 342. Such assembly may include arranging the first sub-component and second sub-component together to form a decorative pattern, where at least a portion of the one or more metallized surface regions, one or more first colored surface regions and one or more second colored regions are visible along a surface to be oriented to an external environment. Further, the assembly process 342 includes coupling the first sub-component to the second sub-component to form the decorative polymeric component assembly, for example, by use of an adhesive or other fastening means, such as a room temperature vulcanization adhesive. The coupling of the first sub-component and the second sub-component together may optionally include applying an adhesive to at least one of the first sub-component or second sub-component and contacting them together under heat and/or pressure to ensure adhesion and joining of the sub-components.

The final polymeric component assembly step 342 may also include buffing the finished surfaces, which may involve buffing rough edges occurring due to the metallization process, and optionally applying an adhesive to a surface of the multi-component assembly that will be coupled to a substrate in the final application or use of the component. Then, the multi-component plastic decorative component assembly can be packed for distribution at 344.

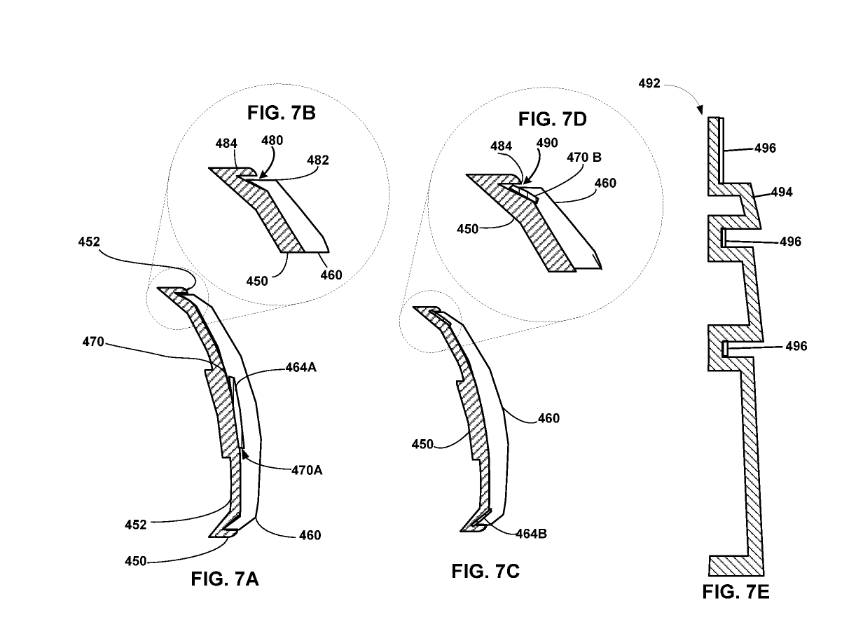

In one embodiment of the present teachings, a multi-polymer plastic decorative component assembly 350 formed in accordance with the present teachings, such as the process described above and shown in FIG. 5 and described above is set forth in FIGS. 6A-B. The polymeric component 350 includes a first sub-component 352 defining at least one metallized surface region 354 that forms a portion of a viewing surface 356 of the component assembly 350 that is metallized. The multi-polymer plastic decorative component assembly 350 also has a second sub-component 358 that includes a second colored polymer having a first color that defines at least one first colored surface region 360 (designated by “x” in FIG. 6B) of surface 356. The metallized surface region 354 may be seen from a viewing perspective (designated by “y” regions) in the surrounding environment 362 adjacent to the colored surface region 360 (“x” regions). The second sub-component 358 also comprises a second colored polymer having a second color that defines at least two second colored surface regions 364 (designated by “z” in FIG. 6B) of surface 356. Together, the first sub-component 352 and the second sub-component 358 are assembled together to define the surface 356 of the component that can be viewed from the surrounding environment 362. As shown in the present embodiment, the first metal-platable polymer forming the metallized surface region(s) 352 and the second and third colored polymers defining the first colored surface region 360 and second colored surface region 364 are substantially flush and level with one another to form surface 356. As appreciated by those of skill in the art, such an embodiment is exemplary, because the first sub-component and the second sub-components may be injection molded (or multi-shot injection molded) to form any number of different configurations, thus forming any number of designs by respective locations of metallized surface 354 and colored surface regions 360, 364.

Although not shown in FIG. 5, as discussed above, a fourth resin (or a plurality of additional resins) may optionally be included in the injection molding process 332. Preferably, like the second and third resins, the fourth resin forms a colored polymer that is optionally stable to UV radiation. In certain aspects, such a fourth resin is a transparent resin that can form a fourth polymer that is a protective layer for the underlying polymers and materials.

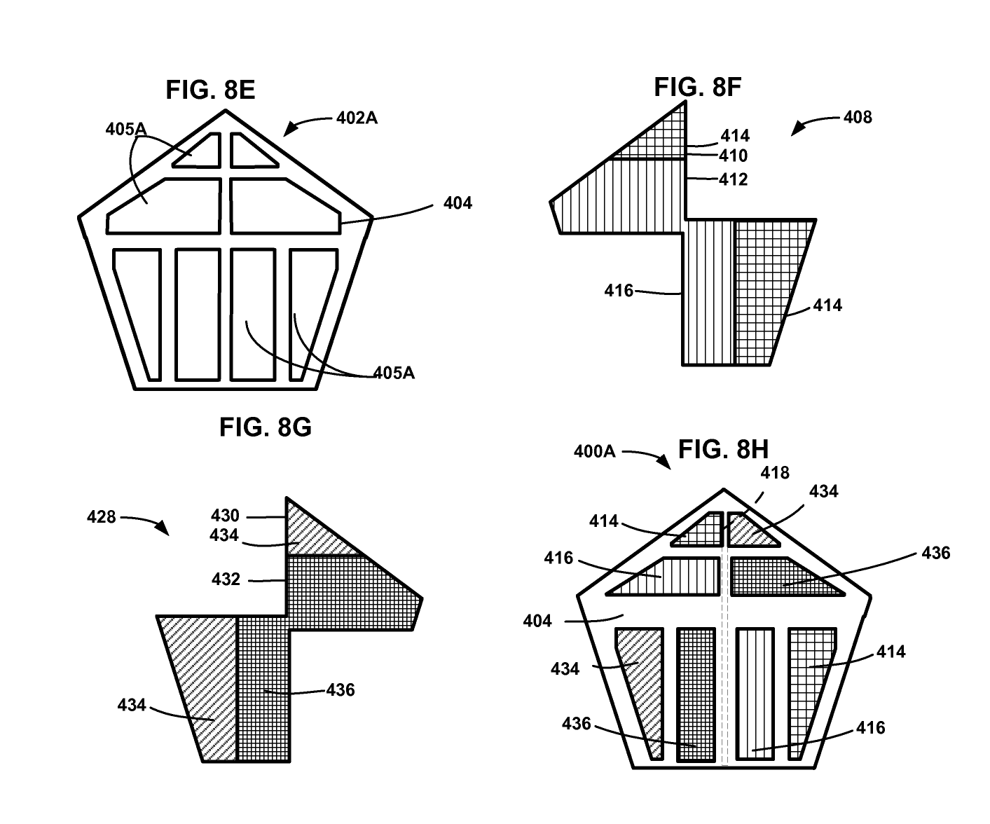

In one embodiment, a multi-polymeric plastic decorative component assembly 400 formed in accordance with the present teachings, such as the process described above and shown in FIG. 5 is set forth in FIGS. 8A-D. A first sub-component 402 includes a metal-platable polymer defining at least one metallized surface region (e.g., a metal-plated surface) 404 (FIG. 8A). The first sub-component 402 has a plurality of apertures 405 in different shapes. In FIG. 8B, a second multi-polymeric sub-component 408 comprises a second polymer 410 having a first color and a third polymer 412 having a second color, where the first and second colors are distinct from one another. Thus, the second polymer 410 defines two surface regions having the first color 414, while the third polymer 412 defines a surface region having the second color 416. In FIG. 8C, the first sub-component 402 and the second sub-component 408 are assembled together so that the first sub-component 402 is a bezel that fits over the central second sub-component 408 (that serves as a backside) to form the assembled component 400. The first and second sub-components 402, 408 are coupled, for example, by the exemplary adhesive 418 (FIG. 8C) disposed between the first and second sub-components 402, 408 to form the polymeric component assembly 400.

In the polymeric component assembly 400, at least a portion of the surface regions having the first color 414 and the surface region having the second color 416 are visible through apertures 405 in the first sub-component 402. Thus, as shown in the sectional view of FIG. 8D, a visible surface 420 of the polymeric component assembly 400 exposed to an external environment 422 includes a plurality of metallized surface regions 404, a colored surface region having a first color 414 and a colored surface region having a second distinct color 416. Further, as shown in the sectional view, the visible surface has a three-dimensional profile, where each of the distinct sub-components 402, 408 and surface finishes 404, 414, 416 is three-dimensionally shaped (to include angles, grooves, and depressions). It should be appreciated that any number of shapes and designs may be formed by the sub-components and assembly, particularly those having both a metallic surface finish and at least two distinct colored surface regions.

FIGS. 8E-H show yet another alternative embodiment of a multi-polymeric plastic decorative component assembly 400A formed in accordance with the present teachings, such as the process described above and shown in FIG. 5. A first sub-component 402A includes a metal-platable polymer defining at least one metallized surface region (e.g., a metal-plated surface) 404 (FIG. 8E). The first sub-component 402A has a plurality of apertures 405A in different shapes. In FIG. 8F, a second multi-polymeric sub-component 408 similar to the one in FIG. 8B comprises a second polymer 410 having a first color and a third polymer 412 having a second color, where the first and second colors are distinct from one another. Such a second sub-component is formed from multi-shot injection molding. Thus, the second polymer 410 defines two surface regions having the first color 414, while the third polymer 412 defines a surface region having the second color 416.

In FIG. 8G, a third multi-polymeric sub-component 428 comprises a fourth polymer 430 having a third color and a fifth polymer 432 having a fourth color, where the third and fourth colors are distinct from one another. Further, the third and fourth colors are distinct from the first and second colors in the second sub-component. Such a third sub-component is formed from multi-shot injection molding. Hence, the fourth polymer 430 defines two surface regions having the first color 434, while the fifth polymer 432 defines a surface region having the second color 436.

In FIG. 8H, the first sub-component 402A, the second sub-component 408, and the third sub-component 428 are assembled together so that the first sub-component 402A is a bezel that fits over overlapping first and second sub-components 408, 428 that are centrally disposed (and together serve as a backside) to form the assembled component 400A. The first, second, and third sub-components 402A, 408, and 428 are coupled, for example, by the exemplary adhesive 418 disposed between the first and second sub-components 402, 408 to form the polymeric component assembly 400A.

In the polymeric component assembly 400A, at least a portion of the respective surface regions having the first color 414, the second color 416, the third color 434, and the fourth color 436 are visible through apertures 405A in the first sub-component 402A. Again, the design shown in FIGS. 8E-8H is merely exemplary and non-limiting, because any number of shapes and designs may be formed by the sub-components and assemblies, particularly those having both a metallic surface finish and at least two distinct colored surface regions.

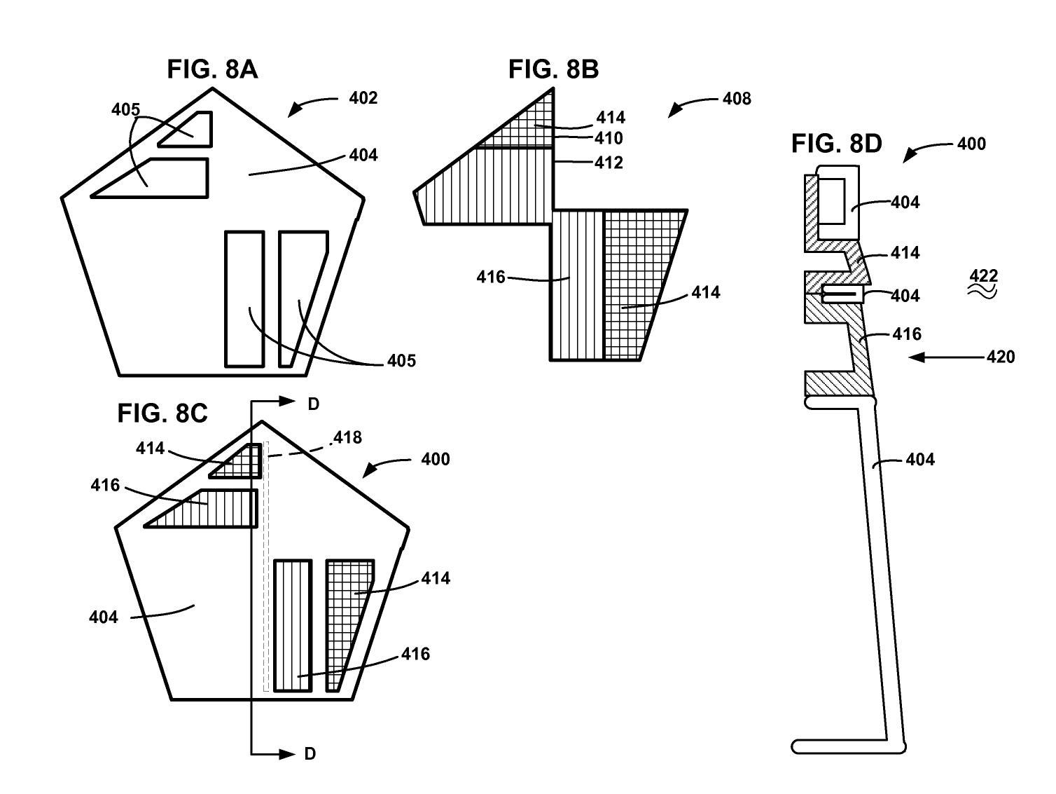

FIGS. 7A-7E depict conventional multi-finish plastic decorative components, where a first component 450 is formed with a first surface finish, like a metallized surface finish 452 (such as in the process discussed in the context of FIG. 1) and a second component 460 is formed with a second surface finish 462, such as a colored surface finish. An adhesive or other fastening means (464A in FIGS. 7A and 464B in FIG. 7B), such as a room temperature vulcanized adhesive, is disposed in a region (470A in FIGS. 7A and 470B in FIG. 7B) between the first component 450 and second component 460 to join them together to form the finished assembly multi-finish plastic decorative component. As shown in the detail of FIG. 7A, even with tight tolerances between the molded components 450, 460, a void or gap 480 can be formed near a terminal end 482 of the first component 450, where it is disposed in a receiving region 484 of the second component 460.

Likewise, in FIG. 7B, a similar gap 490 can be formed near the terminal end 482 of the first component 450, where it is disposed in a receiving region 484 of the second component 460. While adhesive 470B is disposed between the first component 450 and second component 460 near the terminal end 482 of the first component 450, the gap 490 may still create a region where external agents can potentially migrate and cause undesirable degradation or corrosion. Furthermore, in FIG. 7E, a conventional formation technique includes an injection molded polymeric component 492 that includes a metal-platable polymer 494 having a metallized surface finish (similar to the embodiment shown in FIG. 4. A paint 496 is applied over the metal-plated surface 494 and can suffer from delamination, as discussed in the context of FIG. 4.

In certain variations of the present disclosure, the decorative multi-polymer component assembly is further improved to eliminate certain potential issues that may occur with conventional formation processes, for example, to eliminate delamination issues, by avoiding painting over a metallic surface finish. For example, as shown in FIGS. 6A-6B and 8A-8D, the first sub-component having a metal-plated first polymer is separately formed. The second sub-component has a second colored polymer having a first color and a third colored polymer having a second color, distinct from the first polymer. The first and second sub-components are robust, durable, and corrosion resistant, thus when they are assembled together, they do not suffer from the potential for paint delamination or corrosion beneath a lens component, for example, like in the conventional examples of FIGS. 2, 4, and 7A-7E.

In various aspects, suitable polymers for forming the metal platable first polymer include: acrylonitrile-butadiene-styrene (ABS), polycarbonate (PC), acrylonitrile-butadiene-styrene/polycarbonate (ABS/PC), copolymers, equivalents, and combinations thereof. In certain preferred aspects, the first metal-platable polymer comprises acrylonitrile-butadiene-styrene (ABS). Suitable examples of such polymers include those commercially available as CYCOLAC™ MG37EPX-GY4A087, MC1300-GY6026, and MG37EP-GY4A087, which are ABS and ABS-PC copolymers commercially available from SABIC Innovative Plastics. Another suitable polycarbonate polymer is commercially available as TERLURAN™ BX 13074 from BASF, Corp.

In various aspects, the second polymer and the third polymer are independently selected from suitable polymers of the group consisting of: an acrylic polymer, a methacrylic polymer, an acrylic copolymer, a methacrylic copolymer, and combinations thereof. As noted above, particularly suitable polymers for such second and third polymer compositions are UV-stable (or resistant to degradation when exposed to UV radiation). One particularly suitable commercially available second polymer is a colored acrylic copolymer PLEXIGLAS™ V825 UVA acrylic resin sold by Arkema, Inc. which is a proprietary copolymer of ethyl acrylate and methyl methacrylate having UV resistance, a melt flow rate (MFR) of 3.7 g/10 minutes at 230° C., a specific gravity of 1.19, a tensile strength of 10,200 psi and an tensile elongation at break of 6%.

In various aspects, the second polymer has a first color and the third polymer has a second color, where the first and second colors are distinct from one another. In certain aspects, the second polymer and the third polymer may comprise one or more colorants (pigments, dyes, particles) to provide the desired color. It should be appreciated that the second polymer and the third polymer may be the same polymer composition, but may vary in having respectively comprising distinct colorants or surface treatments that create distinct surface finishes or appearances. Likewise, in embodiments where more than two colored polymers are used, such additional polymers may have distinct compositions and/or colors to form the appropriate design, as described above. Suitable colorants include, but are not limited to, dyes and pigments. A pigment is generally an inorganic or organic, colored, white or black material that is usually substantially insoluble in solvents; while a dye, unlike a pigment, is generally soluble in a solvent or carrier. In certain aspects, a preferred colorant for the second and third polymers is a pigment.

By way of non-limiting example, suitable pigment colorants include by way of non-limiting example, pearlescent, iridescent, metallic flake, ultramarine pigments, effect pigments, fluorescent pigments, phosphorescent pigments, inorganic pigments, carbon black pigments, natural pigments, organic pigments, mixed metal oxide pigments, iron oxide pigments, titanium dioxide pigments, organic azo pigments (such as azo lake pigments, insoluble azo pigments, condensed azo pigments, and chelate azo pigments), organic polycyclic pigments (such as phthalocyanine based pigments, anthraquinone based pigments, perylene based pigments, perinone based pigments, indigo based pigments, quinacridone based pigments, dioxazine based pigments, isoindolinone based pigments, quinophthalone based pigments, and diketopyrrolopyrrole (DPP) based pigments), dyeing lake pigments (such as lake pigments of acid or basic dyes), azine pigments; and the like. Further, suitable colorants may include surface-treated pigments.

Likewise, in certain aspects, a fourth resin may be used in certain alternative embodiments to form a transparent protective polymer (which may be the same polymer as the second or third polymers, but lacks colorants) that is selected from the group consisting of an acrylic polymer, a methacrylic polymer, an acrylic copolymer, a methacrylic copolymer, and combinations thereof. One particularly suitable commercially available polymer is a transparent acrylic copolymer PLEXIGLAS™ V825 UVA acrylic resin sold by Arkema, Inc. which is a proprietary copolymer of ethyl acrylate and methyl methacrylate having UV stability/resistance.

In certain alternative embodiments, at least one of the polymeric compositions can contain a reinforcement material. The reinforcement material may include clays, fillers or fibers or the like, which may be used in combination with one another. For example, suitable fibers can include carbon fibers, glass fibers, and combinations thereof.

Thus, the present disclosure provides multi-component polymeric assembly having at least one metallized region on a first sub-component and at least two distinct colored and non-metallized regions on a second sub-component. Such a multi-component polymeric assembly is durable and resistant to corrosion and degradation from extreme weather conditions. While not limiting the present disclosure, in preferred variations, the multi-component polymeric assembly may be a decorative component for a vehicle such as an automobile, truck, van, motorcycle, snowmobile, jet ski, boat, and the like. Such decorative components include detailing and trim features, indicia of brands, logos, emblems, and the like, as well, as instrument panels and other interior design features. Furthermore, such components may be used in a wide variety of applications and are not limited to use merely in vehicles, but rather may be used in a variety of applications, including in components for consumer goods, domestic and industrial appliances, retail and point-of-sale applications, toys, reflector components, and the like.

The multi-injection molding processes of the present teachings are streamlined and more efficient than traditional methods of forming polymeric components having metallized regions and non-metallized regions, including molded components having relative complex designs. The multi-polymer components formed from these processes are durable, corrosion resistant, and yet have improved aesthetics exhibiting well defined metallized region(s) that are visibly distinct from one or more colored regions.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of forming a polymeric component assembly, comprising:
forming a first sub-component via injection molding of a first resin to form a first polymer that is metal-platable and metallizing one or more regions of a surface of the first sub-component to form one or more metallized regions over the first polymer;
forming a second sub-component via multi-shot injection molding of a second resin and a third resin, wherein the second resin forms a second polymer having a first color and the third resin forms a third polymer having a second color, wherein the first and second colors are distinct from one another; and
coupling the first sub-component and the second sub-component together to form the polymeric component assembly, wherein a first colored region is defined by the second polymer corresponding to the first color and a second colored region is defined by the third polymer corresponding to the second color, wherein the first colored region, the second colored region, and the one or more metallized regions form a surface of the polymeric component assembly exposed to an external environment.

2. The method of claim 1, wherein the metallizing further comprises first etching the one or more regions of the surface of the first sub-component followed by at least one plating process selected from the group consisting of: an electroless bath, an electroplating bath, and combinations thereof, to form the one or more metallized regions.

3. The method of claim 2, wherein the one or more metallized regions of the surface of the first sub-component are etched with an etching solution comprising chromium and sulfuric acid, followed by an electroless plating process to deposit at least one metal selected from the group consisting of: nickel (Ni), copper (Cu), and combinations thereof, followed by a first electroplating process to form at least one copper (Cu) layer, a second electroplating process to form at least one nickel (Ni) layer, and a third electroplating process to form at least one chromium layer (Cr).

4. The method of claim 1, further comprising forming a third sub-component via multi-shot injection molding of a fourth resin and a fifth resin, wherein the fourth resin forms a fourth polymer having a third color and the fifth resin forms a fifth polymer having a fourth color, wherein the third and fourth colors are distinct from one another.

5. The method of claim 4, wherein the first color, the second color, the third color, and the fourth color are respectively distinct from one another.

6. The method of claim 1, wherein the forming of the second sub-component via multi-shot injection molding further comprises injecting a fourth resin having a third color after said third resin, wherein said third color is distinct from the first and second colors.

7. The method of claim 1, wherein the coupling of the first sub-component and the second sub-component together comprises applying an adhesive to at least one of the first sub-component or second sub-component and contacting them together under heat and/or pressure.

8. The method of claim 1, wherein the multi-shot injection molding comprises injecting the second resin into a mold at a first injection temperature and injecting the third resin into the mold at a second injection temperature, wherein the first injection temperature is greater than or equal to about 50° C. above the second injection temperature.

9. The method of claim 1, wherein the multi-shot injection molding comprises injecting a second resin into a mold at a first position, then rotating the mold to a second position and injecting the third resin into the mold at the second position.

10. The method of claim 1, wherein the first polymer is selected from the group consisting of: acrylonitrile-butadiene-styrene (ABS), acrylonitrile-butadiene-styrene/polycarbonate (ABS/PC), and combinations thereof; and the second polymer and the third polymer are independently selected from the group consisting of: an acrylic polymer, an acrylic copolymer, a methacrylic polymer, a methacrylic copolymer, and combinations thereof.

11. A polymeric component assembly comprising:
one or more metallized surface regions formed on a first injection-molded polymer that is metal-platable and one or more first colored surface regions defined by a second injection-molded polymer that has a first color and one or more second colored surface regions defined by a third injection-molded polymer having a second color that is distinct from the first color, wherein the second injection-molded polymer and the third injection-molded polymer are integrally formed with one another and coupled to the first injection-molded polymer, wherein at least a portion of the one or more metallized surface regions, one or more first colored surface regions, and the one or more second colored surface regions are visible to an external environment.

12. The polymeric component assembly of claim 11, wherein the first polymer is selected from the group consisting of: acrylonitrile-butadiene-styrene (ABS), acrylonitrile-butadiene-styrene/polycarbonate (ABS/PC), and combinations thereof; and the second polymer and the third polymer are independently selected from the group consisting of: an acrylic polymer, an acrylic copolymer, a methacrylic polymer, a methacrylic copolymer, and combinations thereof.

13. The polymeric component assembly of claim 12, wherein the second polymer and the third polymer are UV-stable polymers.

14. The polymeric component assembly of claim 11, further comprising a fourth injection-molded polymer having a third color, wherein the first color, the second color, and the third color are distinct from one another.

15. The polymeric component assembly of claim 11, wherein the fourth injection-molded polymer is formed separately from and coupled to the first injection-molded polymer.

16. The polymeric component assembly of claim 11, wherein the one or more metallized surface regions comprise a chrome-plating.

17. The polymeric component assembly of claim 16, wherein the chrome-plating comprises a metal selected from the group consisting of: copper (Cu), nickel (Ni), chromium (Cr), and combinations thereof.

18. The polymeric component assembly of claim 11, wherein the one or more metallized surface regions, one or more first colored surface regions, and the one or more second colored surface regions define a three-dimensional surface profile that is visible to the external environment.

19. A decorative polymeric component assembly comprising:
a first sub-component comprising a first injection-molded metal-platable polymer having a surface comprising one or more metallized surface regions;
a second sub-component comprising a second injection-molded polymer and a third injection-molded polymer, wherein the second injection-molded polymer has a first color and the third injection-molded polymer has a second color, wherein the first and second colors are distinct from one another and the second injection-molded polymer and the third injection-molded polymer are integrally formed with one another;
wherein the first sub-component and the second sub-component are coupled together and at least a portion of the one or more metallized surface regions, the second injection-molded polymer and the third injection-molded polymer are visible to an external environment.

20. The decorative polymeric component assembly of claim 19, wherein the first injection-molded metal-platable polymer is selected from the group consisting of: acrylonitrile-butadiene-styrene (ABS), acrylonitrile-butadiene-styrene/polycarbonate (ABS/PC), and combinations thereof; and the second injection-molded polymer and the third injection-molded polymer are independently selected from the group consisting of: an acrylic polymer, an acrylic copolymer, a methacrylic polymer, a methacrylic copolymer, and combinations thereof.
